(19) United States
(12) Patent Application Publication
(10) Pub. No.: US 2007/0247297 A1
(43) Pub. Date: Oct. 25, 2007

(54) Wireless vehicle indicator module

(76) Inventor: Cheng-Chun Chen, Taipei (TW)

Correspondence Address: Cheng-Chun Chen, 235 Chung-Ho, Box 8-24, Taipei, omitted

(21) Appl. No.: 11/522,806

(22) Filed: Sep. 18, 2006

(30) Foreign Application Priority Data
Apr. 19, 2006 (TW) 095206660

(51) Int. Cl. B60Q 1/26

(52) U.S. Cl. 340/468

(57) ABSTRACT

A wireless vehicle indicator module comprises a transmitter unit having four slots for receiving a small lamp wire, a braking lamp wire, a left indicating lamp wire, a right indicator lamp wire; a receiver unit for receiving the RF signals of the small lamp wire, braking lamp wire, left indicating lamp wire and right indicator lamp wire from the transmitter unit; the RF signals being down-converted into base band signals; a left indication light for receiving the signals of the left indicating lamp wire from the receiver unit and then light up; a right indication light for receiving the signals of the right indicator lamp wire from the receiver unit; a small lamp for receiving the signals of the small lamp from the receiver unit and then lights up; and a brake lamp for receiving the signals of the braking lamp wire from the receiver unit and then lights up.

### FIELD OF THE INVENTION

The present invention relates to indicators of vehicles, and particularly to a wireless vehicle indicator module, wherein the wireless vehicle indicator module can be arranged at different positions of the drivers, or different positions of the vehicles so that other drivers can view the modules easily and conveniently so as to protect the safety of the driver in driving.

### BACKGROUND OF THE INVENTION

The prior art vehicle indicators include small lamps, brake lamps, left indication lights and right indication lights. The drivers operates these lamps to indicate the actions of the vehicles so that other drivers at the periphery of the vehicle can know the action of the vehicle. Thereby the traffic safety can be retained. However, conventionally, these lamps are arranged at a lower side of the vehicle which can be not view easily. Thus it is often that drivers must adjust the sight line to see the lamps. Thus, the burden of the driver is increased and the traffic safety becomes worse.

### SUMMARY OF THE INVENTION

Accordingly, the primary object of the present invention is to provide a wireless vehicle indicator module, wherein the wireless vehicle indicator module can be arranged at different positions of the drivers, or different positions of the vehicles so that other drivers can view the modules easily and conveniently so as to protect the safety of the driver.

To achieve above objects, the present invention provides a wireless vehicle indicator module which comprises a transmitter unit having four slots for a small lamp wire, a braking lamp wire, a left indicating lamp wire, a right indicator lamp wire; wherein the transmitter unit receives signals from the small lamp wire, braking lamp wire, left indicating lamp wire and right indicator lamp wire which are then converted into RF signals for transmission; a receiver unit for receiving the RF signals of the small lamp wire, braking lamp wire, left indicating lamp wire and right indicator lamp wire from the transmitter unit; then the RF signals being downconverted into base band signals; a left indication light for receiving the signals of the left indicating lamp wire from the receiver unit and then light up; a right indication light for receiving the signals of the right indicator lamp wire from the receiver unit and then light up; a small lamp for receiving the signals of the small lamp from the receiver unit and then lights up; a brake lamp for receiving the signals of the braking lamp wire from the receiver unit and then light up.

The various objects and advantages of the present invention will be more readily understood from the following detailed description when read in conjunction with the appended drawing.

### BRIEF DESCRIPTION OF THE DRAWINGS

FIG. 1 is a schematic view showing the arrangement of the transmitter unit and receiver unit of the first embodiment of the present invention.

FIG. 2 is a schematic view showing the arrangement of the lamp body of the present invention.

FIG. 3 is a schematic view showing the second embodiment of the present invention, wherein the present invention is applied to a hat.

FIG. 4 is a schematic view showing the third embodiment of the present invention, wherein the present invention is applied to clothes.

FIG. 5 is a schematic view showing the fourth embodiment of the present invention, wherein the present invention is applied to a pair of trousers.

FIG. 6 is a schematic view showing the fifth embodiment of the present invention, wherein the present invention is applied to a car.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

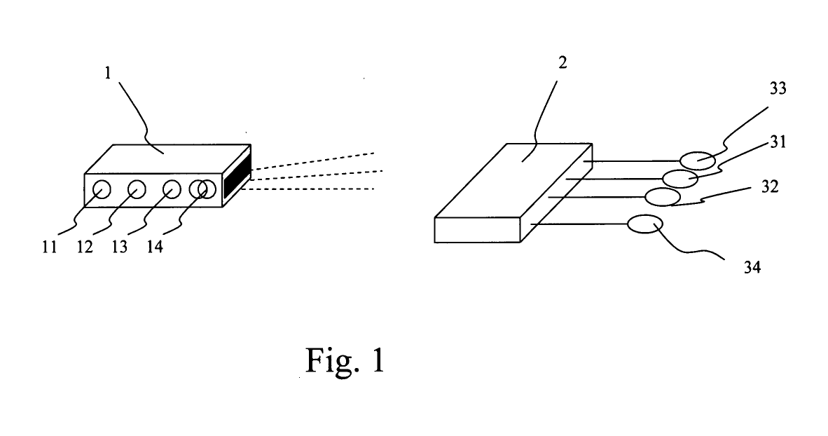

With reference to FIG. 1, the wireless vehicle indicator module of the present invention is illustrated. The present invention has the following elements.

A transmitter unit 1 has four slots for receiving a small lamp wire 11, a braking lamp wire 12, a left indicating lamp wire 13, a right indicator lamp wire 14. The transmitter unit 1 receives signals from the small lamp wire 1 1, braking lamp wire 12, left indicating lamp wire 13 and right indicator lamp wire 14 which are then converted into RF signals for transmission.

A receiver unit 2 serves for receiving the RF signals of the small lamp wire 1 1, braking lamp wire 12, left indicating lamp wire 13 and right indicator lamp wire 14 from the transmitter unit 1. Then the RF signals are down-converted into base band signals.

A left indication light 33 receives the signals of the left indicating lamp wire 13 from the receiver unit 2 and then light up.

A right indication light 34 receives the signals of the right indicator lamp wire 14 from the receiver unit 2 and then light up.

A small lamp 31 serves to receive the signals of the small lamp 31 from the receiver unit 2 and then lights up.

A brake lamp 32 receives the signals of the braking lamp wire 12 from the receiver unit 2 and then light up.

In use, the transmitter unit 1 is arranged in a car, such as a motorcycle or a car. The four slots of the transmitter unit 1 are connected with the small lamp wire 11, braking lamp wire 12, left indicating lamp wire 13 and right indicator lamp wire 14 of the car of the motorcycle. When the driver actuates a switch (not shown) of the left indication light 33, the left indicating lamp wire 13 will be actuated so as to actuate the transmitter unit 1 to transmit the signal of the left indication light 33. The signal is transferred to the receiver unit 2 and is received by the receiver unit 2. Then the receiver unit 2 will actuate the left indication light 33. The same operation can be used to the small lamp 31, right indication light 34, and brake lamp 32.

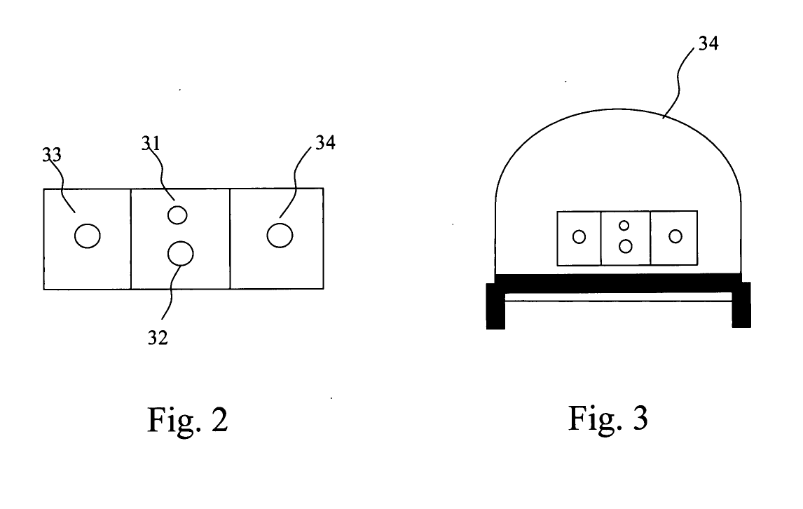

With reference to FIG. 2, the second embodiment of the present invention is illustrated. In this embodiment, the arrangement of the small lamp 31, brake lamp 32, left indication light 33 and right indication light 34 are illustrated. The left indication light 33 and right indication light 34 are arranged at left side and right side. The small lamp 31 and brake lamp 32 are arranged at the middle section and uses a same casing. This arrangement is matched to the conventional arrangement of the small lamp 31, brake lamp 32, left indication light 33 and right indication light 34 in a vehicle.

With reference to FIG. 3, the second embodiment of the present invention is illustrated. It is illustrated that the lamp module of the present invention is arranged on a hat, such as a safety helmet. In the present invention, the wireless vehicle indicator module of the present invention can be integrally formed with the safety helmet 34, or it is installed to the safety helmet 34.

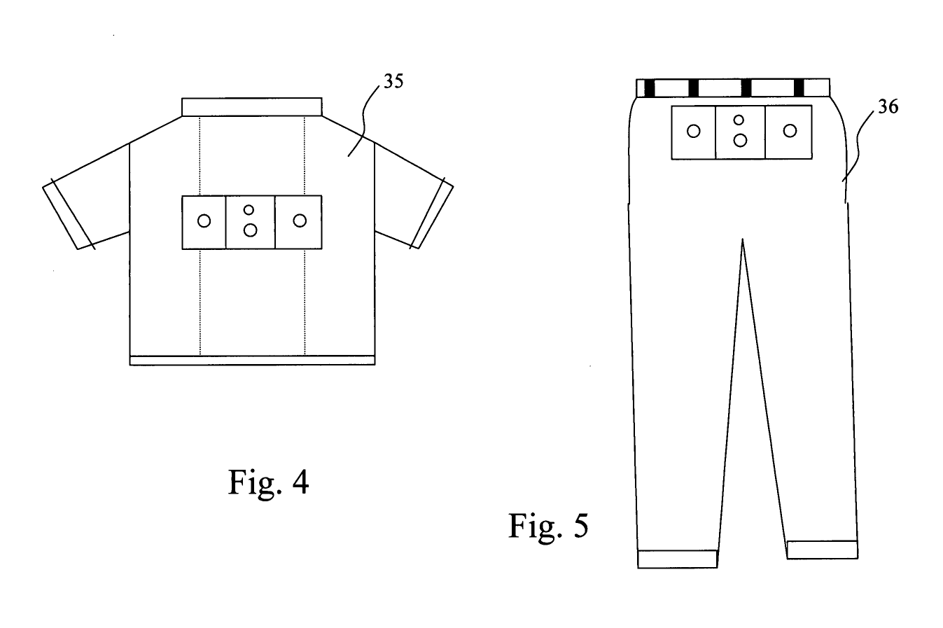

Referring to FIG. 4, the fourth embodiment of the present invention is illustrated. The wireless vehicle indicator module of the present invention can be in arranged on clothes 35. The wireless vehicle indicator module and the cloth 35 can be integrally formed or separated manufactured.

Referring to FIG. 5, the fifth embodiment of the present invention is illustrated. It is illustrated that the wireless vehicle indicator module is arranged on a backside of a trousers 36. The wireless vehicle indicator module and the trousers 36 can be integrally formed or separated manufactured.

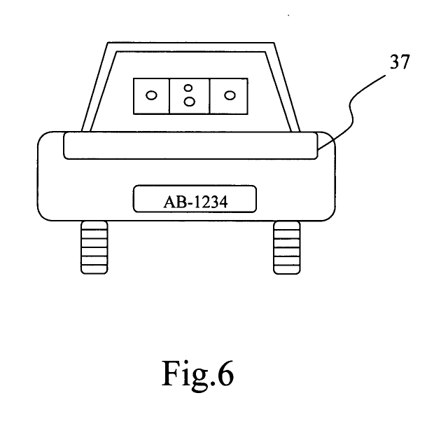

Referring to FIG. 6, the sixth embodiment of the present invention is illustrated. It is illustrated that the wireless vehicle indicator module of the present invention can be arranged at any position of a car. The wireless vehicle indicator module can be integrally formed with the portion of the car or they are formed separately.

Moreover, the present invention can be arranged on a motorcycle. In the present invention, the wireless vehicle indicator module can be bulbs or LEDs. The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wireless vehicle indicator module comprising:
a transmitter unit having four slots for receiving a small lamp wire, a braking lamp wire, a left indicating lamp wire, a right indicator lamp wire; wherein the transmitter unit receives signals from the small lamp wire, braking lamp wire, left indicating lamp wire and right indicator lamp wire which are then converted into RF signals for transmission;
a receiver unit for receiving the RF signals of the small lamp wire, braking lamp wire, left indicating lamp wire and right indicator lamp wire from the transmitter unit; and then the RF signals being down-converted into base band signals;
a left indication light for receiving the signals of the left indicating lamp wire from the receiver unit and then light up;
a right indication light for receiving the signals of the right indicator lamp wire from the receiver unit and then light up;
a small lamp for receiving the signals of the small lamp from the receiver unit and then lights up;
a brake lamp for receiving the signals of the braking lamp wire from the receiver unit and then light up.

2. The wireless vehicle indicator module as claimed in claim. 1, wherein the left indication light and right indication light are arranged at left side and right side; and the small lamp and brake lamp are arranged at the middle section; and the left indication light, the right indication light, the small lamp and the brake lamp use a same casing.

3. The wireless vehicle indicator module as claimed in claim 1, wherein the wireless vehicle indicator module is arranged on a hat.

4. The wireless vehicle indicator module as claimed in claim 1, wherein the wireless vehicle indicator module is formed on a safety helmet.

5. The wireless vehicle indicator module as claimed in claim 1, wherein the wireless vehicle indicator module is arranged on clothes.

6. The wireless vehicle indicator module as claimed in claim 1, wherein the wireless vehicle indicator module is arranged on a set of trousers.

7. The wireless vehicle indicator module as claimed in claim 1, wherein the wireless vehicle indicator module is arranged on a car.

8. The wireless vehicle indicator module as claimed in claim 1, wherein the wireless vehicle indicator module is arranged on a motorcycle.

9. The wireless vehicle indicator module as claimed in claim 1, wherein the wireless vehicle indicator module is arranged on a bicycle.

10. The wireless vehicle indicator module as claimed in claim 1, wherein all the lamps are bulbs.

11. The wireless vehicle indicator module as claimed in claim 1, wherein all the lamps are light emitting diodes.
